(19) United States
(12) Patent Application Publication
(10) Pub. No.: US 2025/0350073 A1
(43) Pub. Date: Nov. 13, 2025

(54) REFRIGERATOR

(71) Applicant: SAMSUNG ELECTRONICS CO., LTD., Suwon-si (KR)

(72) Inventors: Sangky JE, Suwon-si (KR); Jinhee IM, Suwon-si (KR)

(21) Appl. No.: 19/081,293

(22) Filed: Mar. 17, 2025

Related U.S. Application Data
(63) Continuation of application No. PCT/KR2025/099574, filed on Mar. 5, 2025.

(30) Foreign Application Priority Data
May 13, 2024 (KR) 10-2024-0062658

(51) Int. Cl. H01R 13/70; F25D 23/00; H01R 13/447; H01R 13/641; H01R 31/06

(52) U.S. Cl. CPC H01R 13/701; F25D 23/00; H01R 13/447; H01R 13/641; H01R 31/06

(57) ABSTRACT

A refrigerator according to an embodiment of the disclosure may include a main body forming a storage compartment for storing food, a door rotatably connected to the main body to open/close the storage compartment, a control box disposed on one surface of the main body to receive an electrical component for receiving power and controlling an operation of the refrigerator, a power connector electrically connected to the electrical component, and a power cord couplable to or separable from the power connector. The power connector may include a power case, a power socket coupled to the power case and coupled with the power cord, and a power cover couplable to or separable from one surface of the power case to cover the power socket. When coupled with the power case, the power cover may cover the power cord coupled to the power connector while contacting one side of the power cord.

### CROSS-REFERENCE TO RELATED APPLICATIONS

This application is a continuation application of International Application No. PCT/KR2025/099574 designating the United States, filed on Mar. 5, 2025, in the Korean Intellectual Property Receiving Office, which claims priority from Korean Patent Application No. 10-2024-0062658, filed on May 13, 2024, in the Korean Intellectual Property Office, the disclosures of which are hereby incorporated by reference herein in their entireties.

### BACKGROUND

### Field

The disclosure relates to a power connector coupled with a power cord and a refrigerator and a home appliance including the same.

### Description of Related Art

A refrigerator is a home appliance including a main body having a storage compartment and a cold air supply device configured to supply cold air to the storage compartment to keep food fresh.

The refrigerator may include a control box in which electrical components for operating and/or powering the refrigerator are placed. The control box may be equipped with a power connector for connection to an external power source. The power connector may receive power from the external power source via a power cord that may be connected to and disconnected from the power connector.

When using a power cord with such a detachable structure, coupling between the power cord and the power connector may be loosened or the power cord may be separated from the power connector when the refrigerator is used for a long time due to lack of a separate structure that ensures coupling with the power connector. Further, in the event of a fire, there is a risk of the fire spreading because the power cord is exposed.

The above-described information may be provided as related art for the purpose of helping understanding of the disclosure. No claim or determination is made as to whether any of the foregoing is applicable as background art in relation to the disclosure.

### SUMMARY

According to an embodiment of the disclosure, there may be provided a power connector including a power case and a power cover that covers a power cord coupled to the power case and is couplable to or separable from the power case.

A refrigerator according to an embodiment of the disclosure may comprise a main body forming a storage compartment for storing food, a door rotatably connected to the main body to open/close the storage compartment, a control box disposed on one surface of the main body to receive an electrical component for receiving power and controlling an operation of the refrigerator, a power connector electrically connected to the electrical component, and a power cord couplable to or separable from the power connector. The power connector may include a power case, a power socket coupled to the power case and coupled with the power cord, and a power cover couplable to or separable from one surface of the power case to cover the power socket. When coupled with the power case, the power cover may cover the power cord coupled to the power connector while contacting one side of the power cord.

A home appliance according to an embodiment of the disclosure may comprise a main body and a control box disposed on one surface of the main body to receive an electrical component for receiving power and controlling an operation of the refrigerator, a power connector electrically connected to the electrical component, and a power cord couplable to or separable from the power connector. The power connector may include a power case, a power socket coupled to the power case and coupled with the power cord, and a power cover couplable to or separable from one surface of the power case to cover the power socket. When coupled with the power case, the power cover may cover the power cord coupled to the power connector while contacting one side of the power cord.

According to an embodiment of the disclosure, when the power cover couplable to or separable from the power case is coupled to the power case, the power cover comes in contact with one surface of the power cord coupled to the power socket, maintaining coupling between the power socket and the power cord. Further, the power cover covers the power cord coupled to the power socket from outside, reducing the spread of a possible fire.

The disclosure is not limited to the foregoing embodiments but various modifications or changes may rather be made thereto without departing from the spirit and scope of the disclosure.

### BRIEF DESCRIPTION OF THE DRAWINGS

FIG. 1 is a perspective view illustrating an outer appearance of a refrigerator according to an embodiment of the disclosure;

FIG. 2 is a perspective view illustrating a refrigerator with a door open according to an embodiment of the disclosure;

FIG. 3 is a rear view illustrating a refrigerator according to an embodiment of the disclosure;

FIG. 4 is an enlarged view illustrating a portion of a rear surface of a refrigerator representing a control box with a box cover separated and a power connector with a power cover separated, according to an embodiment of the disclosure;

FIG. 5 is a perspective view illustrating a power connector coupled with a power cord according to an embodiment of the disclosure;

FIG. 6 is a perspective view illustrating a state in which a power cord is separated from the power connector of FIG. 5 according to an embodiment of the disclosure;

FIG. 7 is an disassembled perspective view illustrating the power connector of FIG. 5 according to an embodiment of the disclosure;

FIG. 8 is a rear perspective view illustrating a power cover according to an embodiment of the disclosure;

FIG. 9 is a cross-sectional view taken along line A-A′ of FIG. 5 according to an embodiment of the disclosure;

FIG. 10 is a cross-sectional view taken along line B-B′ of FIG. 5 according to an embodiment of the disclosure;

FIG. 11 is a perspective view illustrating a power connector to which a power cord is coupled and in which a power cover is open according to an embodiment of the disclosure;

FIG. 12 is a cross-sectional view illustrating a power connector to which a power cord is coupled and in which a power cover is closed according to an embodiment of the disclosure;

FIG. 13 is a control block diagram illustrating a refrigerator according to an embodiment of the disclosure;

FIG. 14 is a control flowchart illustrating a refrigerator according to an embodiment of the disclosure; and

FIG. 15 is a control flowchart illustrating a refrigerator according to an embodiment of the disclosure.

### DETAILED DESCRIPTION

It should be appreciated that various embodiments of the disclosure and the terms used therein are not intended to limit the technological features set forth herein to particular embodiments and include various changes, equivalents, or replacements for a corresponding embodiment.

With regard to the description of the drawings, similar reference numerals may be used to refer to similar or related elements.

It is to be understood that a singular form of a noun corresponding to an item may include one or more of the things, unless the relevant context clearly indicates otherwise.

As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases.

The term “and/or” may denote a combination(s) of a plurality of related components as listed or any of the components.

As used herein, such terms as “1st” and “2nd,” or “first” and “second” may be used to simply distinguish a corresponding component from another, and does not limit the components in other aspect (e.g., importance or order).

As used herein, the terms ‘front surface,’ ‘rear surface,’ ‘upper surface,’ ‘side surface,’ ‘left side,’ ‘right side,’ ‘upper portion,’ and ‘lower portion’ are defined with respect to the drawings, and the shape and position of each component are not limited by the terms.

It will be further understood that the terms “comprise” and/or “have,” as used herein, specify the presence of stated features, integers, steps, operations, elements, and/or components, but do not preclude the presence or addition of one or more other features, integers, steps, operations, elements, components, and/or groups thereof.

It will be understood that when a component is referred to as “connected to,” “coupled to,” “supported on,” or “contacting” another component, the components may be connected to, coupled to, supported on, or contact each other directly or via a third component.

Throughout the specification, when one component is positioned “on” another component, the first component may be positioned directly on the second component, or other component(s) may be positioned between the first and second component.

The refrigerator according to an embodiment may include a main body.

The “main body” may include an inner case, an outer case disposed outside the inner case, and an insulator provided between the inner case and the outer case.

The “inner case” may include at least one of a case, a plate, a panel, or a liner forming a storage compartment. The inner case may be formed as a single body or may be formed by assembling a plurality of plates. The “outer case” may form the outer appearance of the main body and may be coupled to an outer side of the inner case so that the insulator is disposed between the inner case and the outer case.

The “insulator” may insulate the inside of the storage compartment and the outside of the storage compartment so that the temperature inside the storage compartment is maintained at a set appropriate temperature without being affected by the environment outside the storage compartment. According to an embodiment, the insulator may include a foam insulator. The foam insulator may be formed by injecting and foaming a urethane foam formed by mixing polyurethane and a foaming agent between the inner case and the outer case.

According to an embodiment, the insulator may further include a vacuum insulator in addition to the foam insulator, or the insulator may be composed of only a vacuum insulator instead of the foam insulator. The vacuum insulation material may include a core material and an outer cover material that accommodates the core material and seals the inside at a pressure close to vacuum or vacuum. However, the insulator is not limited to the foam insulator or the vacuum insulator, and may include various materials that may be used for insulation.

The “storage compartment” may include a space limited by the inner case. The storage compartment may further include an inner case that limits a space corresponding to the storage compartment. Various items such as food, medicine, cosmetics, etc. may be stored in the storage compartment, and the storage compartment may be formed so that at least one side thereof is opened to take in and out the items.

The refrigerator may include one or more storage compartments. When two or more storage compartments are formed in the refrigerator, each storage compartment may have a different use and may be maintained at a different temperature. To that end, each storage compartment may be partitioned from each other by a partition wall including an insulator.

The storage compartment may be provided to be maintained in an appropriate temperature range according to the use, and may include a “refrigerating compartment,” a “freezing compartment,” or an “adjustable-temperature compartment” divided by the use and/or temperature range thereof. The refrigerating compartment may be maintained at a temperature suitable for refrigerating and storing items, and the freezing compartment may be maintained at a temperature suitable for freezing and storing items. The term “refrigerating” may mean cooling the item to the extent that the item is not frozen, and for example, the refrigerating compartment may be maintained in the range of 0 degrees Celsius to 7 degrees Celsius. The term “freezing” may mean cooling the item to freeze or remain frozen, and for example, the freezing compartment may be maintained in the range of minus 20 degrees Celsius to minus 1 degree Celsius. The adjustable-temperature compartment may be used as any one of the refrigerating compartment or the freezing compartment regardless of the user's selection.

The storage compartment may be referred to as a “vegetable compartment,” a “fresh compartment,” a “cooling compartment,” an “ice-making compartment,” and the like, in addition to the names “refrigerating compartment,” “freezing compartment,” and “adjustable-temperature compartment,” and the terms “refrigerating compartment,” “freezing compartment,” and “adjustable-temperature compartment” used below should be understood to collectively mean storage compartments having their respective corresponding uses and temperature ranges.

According to an embodiment, the refrigerator may include at least one door configured to open and close one open side of the storage compartment. The door may be provided to open and close each of one or more storage compartments, or one door may be provided to open and close a plurality of storage compartments. The door may be rotatably or slidably installed on the front surface of the main body.

The “door” may be configured to seal the storage compartment when the door is closed. Like the main body, the door may include an insulator to insulate the storage compartment when the door is closed.

According to an embodiment, the door may include a door outer plate forming a front surface of the door, a door inner plate forming a rear surface of the door and facing the storage compartment, an upper cap, a lower cap, and a door insulator provided thereinside.

A gasket may be provided on the edge of the door inner plate to seal the storage compartment by being in close contact with the front surface of the main body when the door is closed. The door inner plate may include a dyke protruding rearward to mount a door basket capable of storing an object.

According to an embodiment, the door may include a door body and a front panel detachably coupled to a front side of the door body and forming a front surface of the door. The door body may include a door outer plate forming a front surface of the door body, a door inner plate forming a rear surface of the door body and facing the storage compartment, an upper cap, a lower cap, and a door insulator provided thereinside.

The refrigerator may be classified into a French door type, a side-by-side type, a bottom mounted freezer (BMF), a top mounted freezer (TMF), or a one-door refrigerator according to the arrangement of the door and the storage compartment.

According to an embodiment, the refrigerator may include a cold air supply device configured to supply cold air to the storage compartment.

The “cold air supply device” may include a machine, an instrument, an electronic device, and/or a system combining the machine, the instrument, and the electronic device capable of generating cold air and guiding the cold air to cool the storage compartment.

According to an embodiment, the cold air supply device may generate cold air through a refrigerating cycle including processes of compressing, condensing, expanding, and evaporating the refrigerant. To that end, the cold air supply device may include a refrigerating cycle device having a compressor, a condenser, an expansion device, and an evaporator capable of driving the refrigerating cycle. According to an embodiment, the cold air supply device may include a semiconductor such as a thermoelectric element. The thermoelectric element may cool the storage compartment by heating and cooling through the Peltier effect.

According to an embodiment, the refrigerator may include a machine room in which at least some components belonging to the cold air supply device are arranged.

The “machine room” may be provided to be partitioned and insulated from the storage compartment to prevent heat generated from components disposed in the machine room from being transferred to the storage compartment. The inside of the machine room may be configured to communicate with the outside of the main body to dissipate heat from components disposed inside the machine room.

According to an embodiment, the refrigerator may include a dispenser provided on the door to provide water and/or ice. The dispenser may be provided on the door to be accessed by the user without opening the door.

According to an embodiment, the refrigerator may include an ice maker provided to generate ice. The ice maker may include an ice making tray storing water, an ice maker separating ice from the ice making tray, and an ice bucket storing ice generated in the ice making tray.

According to an embodiment, the refrigerator may include a controller for controlling the refrigerator.

The “controller” may include a memory storing or recording a program and/or data for controlling the refrigerator, and a processor outputting a control signal for controlling the cold air supply device according to the program and/or data stored in the memory.

The memory stores or records various information, data, instructions, programs, etc. necessary for the operation of the refrigerator. The memory may store temporary data generated while generating a control signal for controlling components included in the refrigerator. The memory may include at least one of a volatile memory and a non-volatile memory or a combination thereof.

The processor controls the overall operation of the refrigerator. The processor may control the components of the refrigerator by executing a program stored in the memory. The processor may include a separate NPU that performs the operation of the artificial intelligence model. The processor may include a central processing unit, a graphics-only processor (GPU), and the like. The processor may generate a control signal for controlling the operation of the cold supply device. For example, the processor may receive temperature information about the storage compartment from the temperature sensor, and generate a cooling control signal for controlling the operation of the cold air supply device based on the temperature information about the storage compartment.

Further, the processor may process the user input of the user interface according to the program and/or data stored/stored in the memory, and control the operation of the user interface. The user interface may be provided using an input interface and an output interface. The processor may receive a user input from the user interface. Further, the processor may transfer a display control signal and image data for displaying an image on the user interface to the user interface in response to the user input.

The processor and the memory may be provided integrally or separately. The processor may include one or more processors. For example, the processor may include a main processor and at least one sub-processor. The memory may include one or more memories.

The refrigerator may include a processor and a memory controlling all components included in the refrigerator, and a plurality of processors and a plurality of memories individually controlling the components of the refrigerator. For example, the refrigerator may include a processor and a memory controlling the operation of the cold air supply device according to the output of the temperature sensor. Further, the refrigerator may include a separate processor and a separate memory controlling the operation of the user interface according to a user input.

The communication module may communicate with an external device such as a server, a mobile device, another home appliance, or the like through an access point (AP). The AP may connect the local area network (LAN) to which the refrigerator or the user equipment is connected to the wide area network (WAN) to which the server is connected. The refrigerator or the user device may be connected to the server through the wide area network (WAN).

The input interface may include a key, a touch screen, a microphone, and the like. The input interface may receive a user input and transfer the user input to the processor.

The output interface may include a display, a speaker, and the like. The output interface may output various notifications, messages, information, and the like generated by the processor.

The refrigerator 1 described below may be understood as an example to help understand the disclosure, and it may be understood that various changes may be made thereto. Further, in some of the accompanying drawings, some components may be shown as exaggerated, rather than real, for a better understanding.

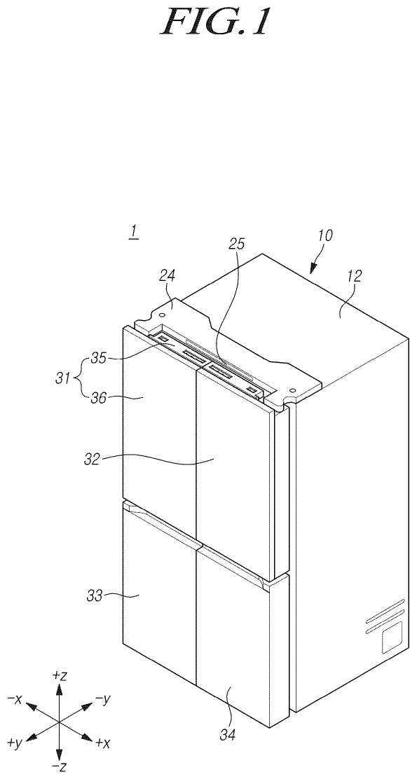

FIG. 1 is a perspective view illustrating an outer appearance of a refrigerator according to an embodiment of the disclosure.

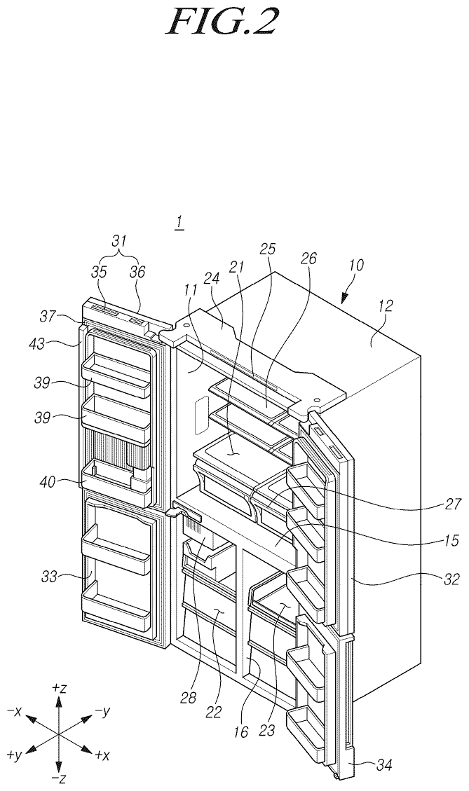

FIG. 2 is a perspective view illustrating a refrigerator with a door open according to an embodiment of the disclosure.

Referring to FIGS. 1 and 2, a refrigerator 1 may include a main body 10, storage compartments 21, 22, and 23 formed inside the main body 10, doors 31, 32, 33, and 34 for opening and closing the storage compartments 21, 22, and 23, and a cold air supply device (not shown) for supplying cold air to the storage compartments 21, 22, and 23.

According to an embodiment, the main body 10 may include an inner case 11 forming the storage compartments 21, 22 and 23, an outer case 12 coupled to the outer side of the inner case 11 to form the outer appearance, and an insulation material (not shown) provided between the inner case 11 and the outer case 12 to insulate the storage compartments 21, 22, and 23.

According to an embodiment, the storage compartments 21, 22, and 23 may be divided into a plurality of ones by a horizontal partition wall 15 and a vertical partition wall 16. The storage compartments 21, 22, and 23 may be divided into an upper storage compartment 21 and lower storage compartments 22 and 23 by the horizontal partition wall 15. The lower storage compartments 22 and 23 may be divided into a left lower storage compartment 22 and a right lower storage compartment 23 by the vertical partition wall 16. The upper storage compartment 21 may be used as a refrigerating compartment, and the lower storage compartments 22 and 23 may be used as freezing compartments, although other configurations are possible in other embodiments. However, the division and use of the storage compartments 21, 22, and 23 are merely an example, and the disclosure is not limited thereto. Unlike in the drawings, the refrigerator 1 may be of a side-by-side (SBS) type in which the storage compartments are divided into left and right ones by a vertical partition wall, a French door refrigerator (FDR) type in which the storage compartments are divided into upper and lower refrigerating compartments by a horizontal partition wall, or a one-door type with one storage compartment and one door.

According to an embodiment, a shelf 26 for placing food on and a storage container 27 for storing food in may be provided inside the storage compartments 21, 22, and 23.

According to an embodiment, the cold air supply device (not shown) may be configured to generate cold air using a cooling circulation cycle that compresses, condenses, expands, and evaporates the refrigerant, and supply the generated cold air to the storage compartments 21, 22, and 23.

According to an embodiment, the doors 31, 32, 33, and 34 may be rotatably connected to the main body 10. The doors 31, 32, 33, and 34 may include a first door 31 positioned at the upper left, a second door 32 positioned at the upper right, a third door 33 positioned at the lower left, and a fourth door 44 positioned at the lower right. The first door 31 and the second door 32 may be referred to as a pair of upper doors 31 and 32, and the third door 33 and the fourth door 34 may be referred to as a pair of lower doors 33 and 34.

According to an embodiment, the upper storage compartment 21 may be opened and closed by the pair of upper doors 31 and 32. The upper doors 31 and 32 may be rotatably coupled to the main body 10. According to an embodiment, the lower storage compartments 22 and 23 may be opened and closed by the pair of lower doors 33 and 34, respectively. The lower doors 33 and 34 may be rotatably coupled to the main body 10.

According to an embodiment, the doors 31, 32, 33, and 34 may include door baskets 39 and 40 having a door storage space for storing food. A gasket 37 which tightly contacts the front surface of the main body 10 may be provided on the rear surface of the door 31, 32, 33, and 34 to seal the storage compartment 21, 22, and 23 when the doors 31, 32, 33, and 34 are closed. The gasket 37 may be disposed along the rear edge of the door 31, 32, 33, and 34.

According to an embodiment, at least one of the doors 31, 32, 33, and 34 may be configured as a dual-door structure having an inner door 35 and an outer door 36. For example, the left upper door 31 may include the inner door 35 and the outer door 36. It should be appreciated that other of the doors 32, 33, and 34 can include the dual-door structure instead of or in addition to the door 31.

According to an embodiment, the outer door 36 may be provided to open and close the door inner space of the inner door 35. A gasket (not shown) may be provided on the rear surface of the outer door 36 to seal the inner space of the door when the outer door 36 is closed. The gasket may be disposed around the inner space of the door to tightly contact the front surface of the inner door 35.

According to an embodiment, when the outer door 36 is opened, it may approach the inner space of the inner door 35. The outer door 36 may be rotatably coupled to the inner door 35 through a hinge (not shown). The outer door 36 may rotate in the same direction as the inner door 35. The outer door 36 may have a size substantially corresponding to the size of the inner door 35. The outer door 36 may cover an entire area of the inner door 35.

According to an embodiment, a decorative panel (not shown) may be detachably coupled to the front surface of the outer door 36.

According to an embodiment, a top cover 24 may be coupled to an upper surface of the main body 10. The top cover 24 may be provided to cover the hinge and various electrical component disposed on the upper surface of the main body 10. A control panel 25 may be provided on the front surface of the top cover 24 to display various states and operation information about the refrigerator 1 or to input various commands for operating the refrigerator 1.

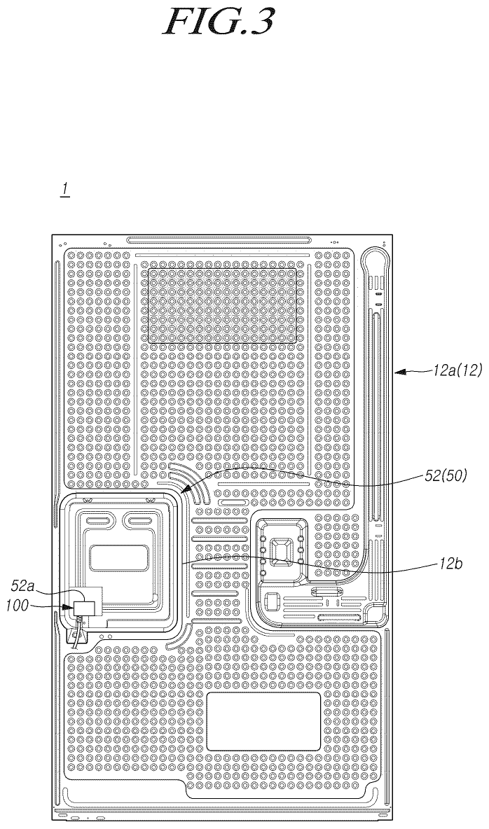

FIG. 3 is a rear view illustrating a refrigerator according to an embodiment of the disclosure.

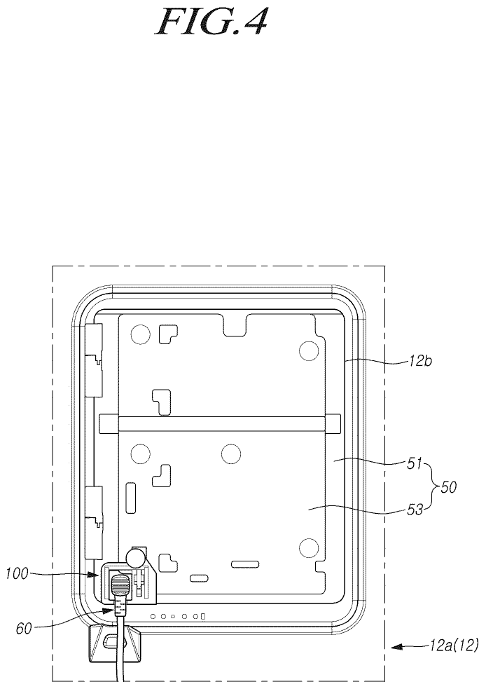

FIG. 4 is an enlarged view illustrating a portion of a rear surface of a refrigerator representing a control box with a box cover separated and a power connector with a power cover separated, according to an embodiment of the disclosure.

The embodiments of FIGS. 3 and 4 may at least partially correspond to the embodiments of FIGS. 1 and 2. The embodiments of FIGS. 3 and 4 may be selectively combined with the embodiments of FIGS. 1 and 2.

Referring to FIGS. 3 and 4, the outer case 12 of the refrigerator 1 may include a rear plate 12a forming the rear surface (or back surface) of the refrigerator 1. A control box 50 in which an electrical component (e.g., the circuit board 53) for controlling the operation of the refrigerator 1 or supplying power to the refrigerator 1 may be disposed on the rear plate 12a. The control box 50 may be fixed to the inside of the refrigerator 1 through an installation hole 12b formed in the rear plate 12a. For example, the control box 50 may be inserted into the refrigerator 1 through the installation hole 12b and disposed between the inner case 11 and the outer case 12 of the refrigerator 1.

According to an embodiment, the control box 50 may include a box housing 51 forming an inner space for receiving or placing an electrical component and a box cover 52 for shielding the inner space of the box housing 51 from the outside.

According to an embodiment, one side of the box housing 51 is open, and the electrical component may be disposed therein through the open side. One side of the open box housing 51 may communicate with the installation hole 12b of the rear plate 12a.

According to an embodiment, the box cover 52 may be coupled to the rear plate 12a of the refrigerator 1 to cover the open one side of the box housing 51. For example, the box cover 52 may be coupled to the installation hole 12b to cover the installation hole 12b of the rear plate 12a. The box cover 52 may be designed to have a shape and/or size corresponding to the installation hole 12b. The box cover 52 may include a through hole 52a through which the power connector 100 passes when the box cover 52 and the box housing 51 are coupled. The power connector 100 may be accessible from the outside through the through hole 52a.

According to an embodiment, the electrical component disposed in the control box 50 may include a power connector 100 for supplying power to a circuit board (e.g., a PCB) 53 or the refrigerator 1.

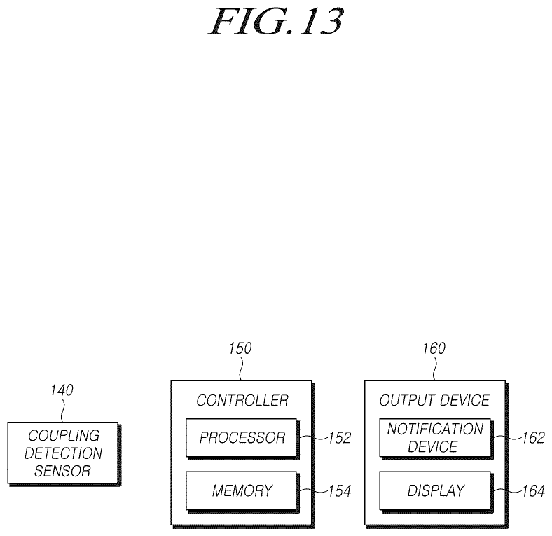

According to an embodiment, the circuit board 53 may include a processor (e.g., the processor 152 of FIG. 13) for controlling the operation and/or power of an electronic device (or an electrical component other than the circuit board 53) disposed inside the refrigerator 1, such as the cold air supply device, and a memory (e.g., the memory 154 of FIG. 13) for storing data and/or programs including commands regarding the operation of the electronic device. The processor and the memory may constitute a controller (e.g., the controller 150 of FIG. 13) for controlling the operation of the refrigerator 1. A description of the controller is made below with reference to FIG. 13.

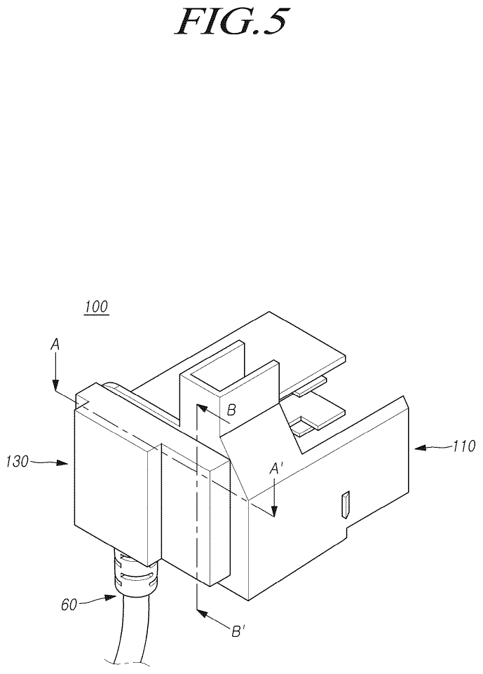

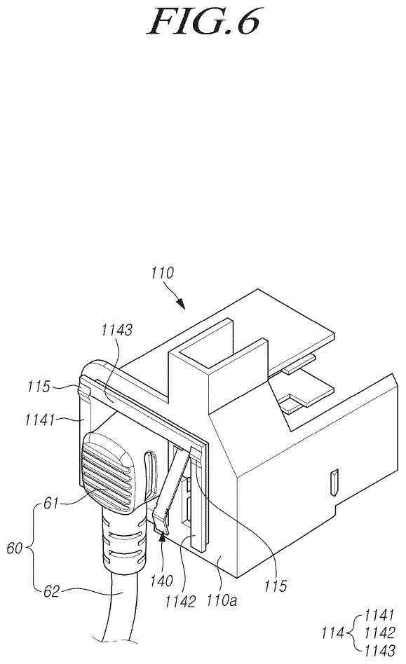

According to an embodiment, the power connector 100 may be electrically connected to the circuit board 53 or may be electrically connected to an electronic device disposed inside the refrigerator 1 through the circuit board 53. In an embodiment, the power connector 100 may be connected to an external power source (not shown) (e.g., a commercial power source) through a power cord 60. The power connector 100 connected to the external power source may receive electricity from the external power source and transfer the supplied electricity to the circuit board 53 and/or the electronic device disposed inside the refrigerator to supply power to the refrigerator 1. In an embodiment, a plug 61 (shown in FIG. 6) of the power cord 60 may be coupled to or separated from the power connector 100. In an embodiment, the power connector 100 may be spaced apart from the circuit board 53. In an embodiment, the power connector 100 may be disposed on the circuit board 53. Hereinafter, the structure of the power connector 100 is described below with reference to FIGS. 5 to 7.

FIG. 5 is a perspective view illustrating a power connector coupled with a power cord according to an embodiment of the disclosure.

FIG. 6 is a perspective view illustrating a state in which a power cord is separated from the power connector of FIG. 5 according to an embodiment of the disclosure.

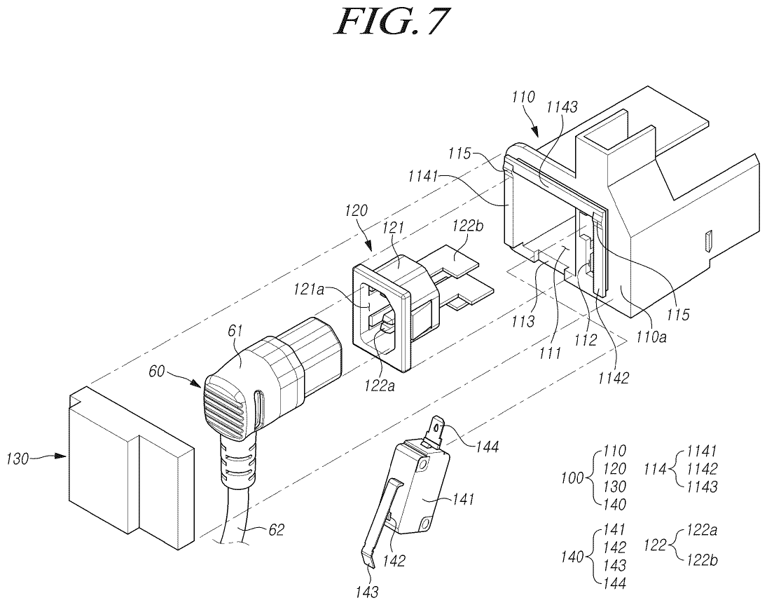

FIG. 7 is a disassembled perspective view illustrating the power connector of FIG. 5 according to an embodiment of the disclosure.

The embodiments of FIGS. 5 to 7 may at least partially correspond to the embodiments of FIGS. 1 to 6. The embodiments of FIGS. 5 to 7 may be selectively combined with the embodiments of FIGS. 1 to 6.

According to one or more embodiments, the configuration of the power connector 100 shown in FIGS. 5 to 7 may be identical in whole or part to the configuration of the power connector 100 shown in FIGS. 3 and 4.

Referring to FIGS. 5 to 7, the power connector 100 according to an embodiment may include a power case 110 forming an outer appearance of the power connector 100, a power socket 120 for coupling with the power cord 60, and a power cover 130 for covering one side of the power cord 60 coupled to the power socket 120.

According to an embodiment, the power case 110 may be configured to fix the power socket 120 and/or a coupling detection sensor 140 to be described below to the inside thereof. In an embodiment, the power case 110 may include a socket coupler 111 penetrating the front surface 110a and the rear surface of the power case 110 and fixing the power socket 120 to the inside thereof. In an embodiment, the power case 110 may include a sensor coupler 112 penetrating the front surface 110a and the rear surface of the power case 110 and fixing the coupling detection sensor 140 to the inside thereof. The socket coupler 111 and the sensor coupler 112 may be disposed adjacent to each other and may be spaced apart (e.g., separated) from each other. When the coupling detection sensor 140 is omitted due to a need such as for design, the sensor coupler 112 may be omitted together with the coupling detection sensor 140. In an embodiment, the power case 110 may include a guide recess 113 positioned under the opening of the socket coupler 111 in the front surface 110a area to draw out the wire 62 of the power cord 60 coupled to the socket coupler 111 to the outside.

In an embodiment, the power case 110 may be formed of a flame-retardant material to reduce the spread of fire that may occur due to a short circuit, damage (e.g., aging) to the power cord 60, or incomplete coupling (or contact) of the power cord 60. For example, the power cover 130 may be formed of a flame-retardant plastic material. The flame-retardant plastic material may include at least one of polypropylene resin, magnesium hydroxide, melamine-based resin, talc, rubber, glass fiber, and/or a coupling agent.

According to an embodiment, the power socket 120 may be inserted into and fixed to the socket coupler 111 of the power case 110. In an embodiment, the power socket 120 may include connection terminals 122 for electrical connection between the socket body 121 and an electrical component including the circuit board 53.

In an embodiment, the socket body 121 may include a plug coupler 121a into which the plug 61 of the power cord 60 is inserted. One end portion 122a of the connection terminal 122 of the power socket 120 connected to the terminal of the plug 61 inserted into the plug coupler 121a may be disposed in the plug coupler 121a. For example, one end portion 122a of the connection terminal 122 of the power socket 120 may be seen from the outside by being placed on the plug coupler 121a. For example, the other end portion 122b of the connection terminal 122 of the power socket 120 may be disposed in the inside opposite to the plug coupler 121a and may be electrically connected to an electrical component including the circuit board 53 through a wire or circuit. The power socket 120 may function as a connector to supply power supplied from an external power source through the power cord 60 to the electrical component including the circuit board 53.

As illustrated in FIG. 4, the power socket 120 may be disposed in the power case 110 provided separately from the circuit board 53, but the disclosure is not limited thereto. For example, in some embodiments, the power socket 120 may be coupled to (or disposed on) the circuit board 53 with the power case 110 omitted.

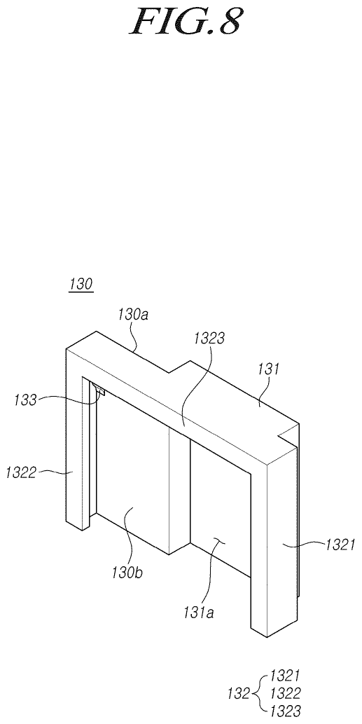

According to an embodiment, the power cover 130 may be coupled to or separated from the power case 110. For example, the power cover 130 may be slidably coupled to or separated from the power case 110. In an embodiment, the power cover 130 covers one side (e.g., rear) of the power cord 60 coupled to the power socket 120, and may be coupled to the power case 110 to contact (or apply pressure to) one side of the power cord 60. For example, when the power case 110 coupled with the power cord 60 and the power cover 130 are coupled, the one side of the power cord 60 exposed to the outside may contact or have pressure applied by one side surface (e.g., the inner surface 130b of FIG. 8) of the power cover 130. As the power cord 60 is brought into contact (or pressure is applied) by the power cover 130, the coupling between the power socket 120 and the power cord 60 may be strengthened.

Hereinafter, a slide coupling structure between the power cover 130 and the power case 110 is described below with reference to FIGS. 8 to 12.

According to an embodiment, the power cover 130 may be formed of the same flame-retardant material as the power case 110 in order to reduce the spread of fire. As described above, the power cover 130 may be formed of, e.g., a flame-retardant plastic material, and the flame-retardant plastic may include at least one of polypropylene resin, magnesium hydroxide, melamine resin, talc, rubber, glass fiber, and/or a coupling agent.

According to an embodiment, the power connector 100 may further include a coupling detection sensor 140 for detecting whether the power cover 130 is completely coupled to the power case 110. In an embodiment, the coupling detection sensor 140 may be inserted into and fixed to the sensor coupler 112 of the power case 110. Whether the power case 110 and the power cover 130 are completely coupled may indicate that one side of the power cord 60 coupled to the power case 110 is blocked from the outside to be invisible by the power cover 130. The coupling detection sensor 140 may include at least one of, e.g., a micro switch (or limit switch), a reed switch, and/or a hall sensor (e.g., a hall integrated circuit (IC)).

As shown in the drawings, when the coupling detection sensor 140 is provided as a micro switch 140, the micro switch 140 may include a switch case 141, a contact part 142 disposed outside the switch case 141 and, when coupled with the power cover 130, deformed while contacting the power cover 130, an actuator (or a snap mechanism) (e.g., a button) 143 operated based on the deformation of the contact part 142, and a terminal 144 disposed inside the switch case 141 and having the contact varied based on the operation of the actuator 143. When the power case 110 and the power cover 130 are coupled, the micro switch 140 may detect whether current is opened or closed based on the operation of the actuator 143 based on the deformation of the contact part 142. The controller, which is described below, may be configured to determine whether the power case 110 and the power cover 130 are completely coupled based on whether the current is opened or closed.

Unlike in this drawings, when the coupling detection sensor 140 is provided as a hall sensor or a reed switch using magnetic action, a magnetic body may be disposed on one surface of the power cover 130 facing the coupling detection sensor 140. The hall sensor or the reed switch may detect a current generated by an electromagnetic action between the magnetic body of the power cover 130 when the power case 110 and the power cover 130 are coupled. The controller, which is described below, may be configured to determine whether the power case 110 and the power cover 130 are completely coupled based on the intensity of the generated current.

FIG. 8 is a rear perspective view illustrating a power cover according to an embodiment of the disclosure.

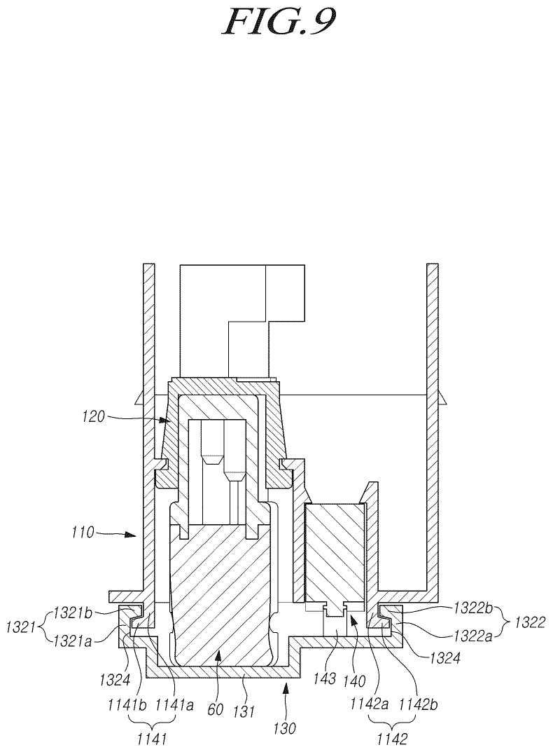

FIG. 9 is a cross-sectional view taken along line A-A′ of FIG. 5 according to an embodiment of the disclosure.

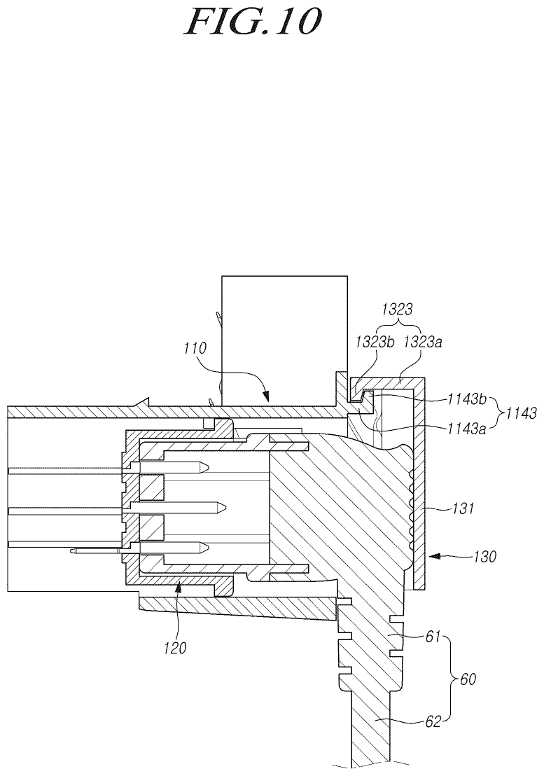

FIG. 10 is a cross-sectional view taken along line B-B′ of FIG. 5 according to an embodiment of the disclosure.

FIGS. 9 and 10 are cross-sectional views of a power connector 100 coupled with a power cord 60 representing a structure for slidable coupling of the power case 110 and the power cover 130.

The embodiments of FIGS. 8 and 9 may correspond to the embodiments of FIGS. 1 to 8. At least some of the embodiments of FIGS. 8 and 9 may be at least partially combined with the embodiments of FIGS. 1 to 8.

According to one or more embodiments, the configuration of the power cover 130 of FIG. 8 may be identical in whole or part to the configuration of the power cover 130 of FIGS. 5 and 7. According to one or more embodiments, the configuration of the power connector 100 of FIGS. 9 and 10 may be identical in whole or part to the configuration of the power connector 100 of FIGS. 3 to 7.

Referring to FIGS. 8 to 10, the power connector 100 according to an embodiment may include a power case 110 and a power cover 130 that may slide with respect to the power case 110 to be coupled to or separated from the power case 110.

According to an embodiment, the power cover 130 may include a cord receiver 131 configured to receive at least a portion of the power cord 60 inside when coupled with the power case 110 to which the power cord 60 is coupled. In an embodiment, the cord receiver 131 may protrude from the outer surface 130a of the power cover 130 to form a step with the outer surface 130a. In an embodiment, the cord receiver 131 may include a recess 131a recessed from the inner surface 130b of the power cover 130. The recess 131a may form a step with the inner surface 130b, and may surround at least a portion of the power cord 60 when coupled with the power case 110 to which the power cord 60 is coupled.

According to an embodiment, the power cover 130 may include a side wall 132 extending along a portion of the edge of the inner surface 130b of the power cover 130. In an embodiment, the side wall 132 may include a left side wall 1321 disposed on the left end on the inner surface 130b of the power cover 130, a right side wall 1322 disposed on the right end on the inner surface 130b of the power cover 130, and an upper side wall 1323 disposed on the upper end of the inner surface 130b of the power cover 130 and connecting the left side wall 1321 to the right side wall 1322. The side walls 1321, 1322, and 1323, respectively, may include supporting portions 1321a, 1322a, and 1323a protruding from the inner surface 130b of the power cover 130, and fastening portions 1321b, 1322b, and 1323b bent vertically inward from the supporting portions 1321a, 1322a, and 1323a. The left side wall 1321 may be referred to as a first side wall 1321, the right side wall 1322 may be referred to as a second side wall 1322, and the upper side wall 1323 may be referred to as a third side wall 1323. The lower end of the inner surface 130b of the power cover 130 may have no side wall, and thus may be open. When the power case 110 to which the power cord 60 is coupled and the power cover 130 are coupled, the wire 62 of the power cord 60 may be drawn out and extended to the outside through the lower end of the open side wall 132.

According to an embodiment, the power cover 130 may include a pair of guide protrusions 133 provided at positions adjacent to the left/right side walls 1321 and 1322, respectively, of the side wall 132 on the inner surface 130b. Each of the guide protrusions 133 may have a curved surface. The guide protrusion 133 of the power cover 130 may be referred to as a first guide protrusion 133.

According to an embodiment, the power case 110 may include a slide rib 114 extending along a portion of the edge of the socket coupler 111 and the sensor coupler 112 to surround the socket coupler 111 and the sensor coupler 112. For example, the slide rib 114 may be provided in the remaining area of the area of the front surface 110a adjacent to the opening of each of the socket coupler 111 and the sensor coupler 112 except for the area positioned below the opening.

In an embodiment, the slide rib 114 may include a first rib 1141 positioned on the left side of the opening of the socket coupler 111, a second rib 1142 positioned on the right side of the opening of the sensor coupler 112, and a third rib 1143 positioned on the opening of each of the socket coupler 111 and the sensor coupler 112 and connecting the first rib 1141 and the second rib 1142. The ribs 1141, 1142, and 1143, respectively, may include supporting portions 1141a, 1142a, and 1143a protruding from the front surface 110a of the power case 110 and fastening portions 1141b, 1142b, and 1143c bent vertically outward from the supporting portions 1141a, 1142a, and 1143a. The slide rib 114 may form a space (or recess) into which a portion (e.g., the fastening portions 1321b, 1322b, and 1323c) of the side wall 132 of the power cover 130 is inserted between the front surface 110a of the power case 110 and the fastening portions 1141b, 1142b, and 1143c through the structure of the ribs 1141, 1142, and 1143.

When the power cover 130 is coupled to or separated from the power case 110, the power cover 130 may be coupled to or separated from the power case 110 by sliding along the extending direction of the first rib 1141 and the second rib 1142 as the slide rib 114 of the power case 110 and the side wall 132 of the power cover 130 are engaged with each other. For example, the first and second ribs 1141 and 1142 of the slide rib 114 of the power case 110 may be engaged, respectively, with the left and right side walls 1321 and 1322 of the side wall 132 of the power cover 130, guiding the slide of the power cover 130. For example, the third rib 1143 of the slide rib 114 of the power case 110 may function as a stopper that restricts the slide of the power cover 130 by engaging with the upper side wall 132 of the side wall 132 of the power cover 130.

In an embodiment, the power case 110 may include a pair of guide protrusions 115 (shown in FIG. 6) protruding from the respective surfaces of the first and second ribs 1141 and 1142 of the slide rib 114. Each of the guide protrusions 115 may have a curved surface. The guide protrusion 115 of the power case 110 may be referred to as a second guide protrusion 115.

When the power case 110 and the power cover 130 are coupled, the guide protrusion 115 of the power case 110 may engage with the guide protrusion 133 of the power cover 130, and may be positioned higher than the guide protrusion 133 of the power cover 130. The guide protrusions 115 and 133 of the power cover 130 and the power case 110 may function as stoppers (or detents) in the slide-coupling process of the power cover 130.

Unlike in the drawings, in some embodiments, the power cover 130 may be coupled to the power case 110 by a fastening member, such as a screw or other suitable fastening member.

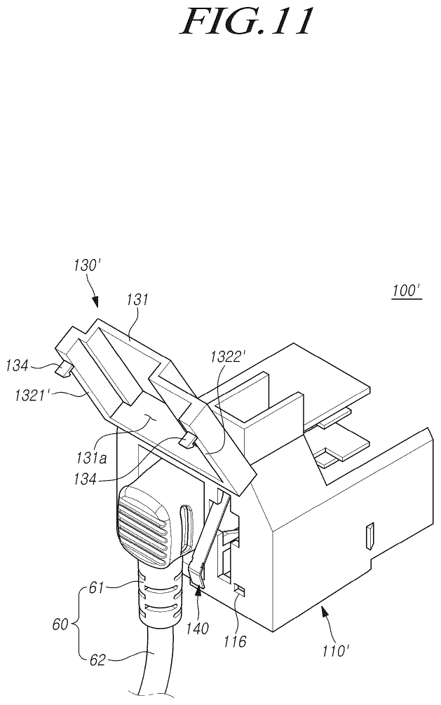

FIG. 11 is a perspective view illustrating a power connector to which a power cord is coupled and in which a power cover is open according to an embodiment of the disclosure.

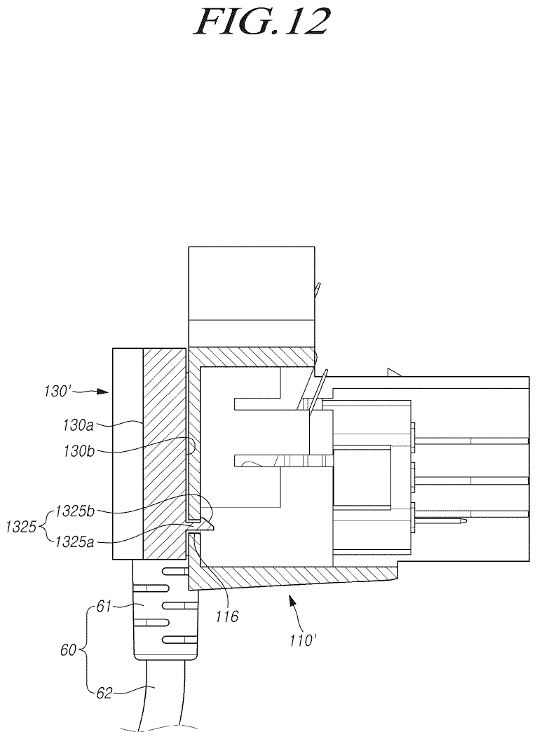

FIG. 12 is a cross-sectional view illustrating a power connector to which a power cord is coupled and in which a power cover is closed according to an embodiment of the disclosure.

FIGS. 11 and 12 are perspective and cross-sectional views, respectively, of a power connector 100′ coupled with a power cord 60 representing a structure for hinge coupling between the power case 110′ and the power cover 130′.

The embodiments of FIGS. 11 and 12 may correspond to the embodiments of FIGS. 1 to 10, and at least some of the embodiments of FIGS. 11 and 12 may be selectively combined with the embodiments of FIGS. 1 to 10.

According to one or more embodiments, the configuration of the power connector 100′ of FIGS. 11 and 12 may be identical in whole or part to the configuration of the power connector 100 of FIGS. 3 to 10.

Referring to FIGS. 11 and 12, the power connector 100′ according to an embodiment may include a power case 110′ and a power cover 130′ rotatably connected to the power case 110′.

According to an embodiment, the power cover 130′ may be rotatably connected to the front surface 110a of the power case 110′ through a hinge device (not shown). In an embodiment, the power cover 130′ may rotate with respect to the power case 110′ to open and close a portion of the front surface 110a of the power case 110′. For example, the power cover 130′ may rotate to one side to close a portion of the front surface 110a of the power case 110′, covering the power socket (e.g., the power socket 120 of FIG. 7) and the coupling detection sensor 140 disposed in the power case 110′. For example, the power cover 130′ may rotate to the other side to open a portion of the front surface 110a of the power case 110′, allowing the power socket and the coupling detection sensor 140 disposed in the power case 110′ to be accessible from the outside.

According to an embodiment, the power cover 130′ may include a side wall 132′ extending along a portion of the edge of the inner surface 130b of the power cover 130′. In an embodiment, the side wall 132 may include a left side wall 1321′ disposed on the left end on the inner surface 130b of the power cover 130′, a right side wall 1322′ disposed on the right end on the inner surface 130b of the power cover 130′, and an upper side wall 1323′ disposed on the upper end of the inner surface 130b of the power cover 130′.

According to an embodiment, a fixing protrusion 134 for fixing the power cover 130′ to the power case 110′ may be provided on each of the left side wall 1321′ and the right side wall 1322′. In an embodiment, the fixing protrusion 134 may include an extension portion 134a protruding from the left/right side walls 1321′ and 1322′ and a fixing portion 134b provided at the free end of the extension portion 134a and having an inclined surface.

According to an embodiment, a pair of fixing holes 116 into which the fixing protrusions 134 are inserted may be formed on the front surface 110a of the power case 110′. Each of the fixing holes 116 may be provided at a position corresponding to the fixing protrusion 134 when the power cover 130′ is closed. For example, the respective fixing holes 116 may be disposed in the left area of the opening of the socket coupler (e.g., the socket coupler 111 of FIG. 7) of the front surface 110a of the power case 110′ and the right area of the opening of the sensor coupler (e.g., the sensor coupler 112 of FIG. 7). When the power cover 130′ is closed, the fixing protrusion 134 of the power cover 130′ may be inserted into the fixing hole 116 of the power case 110′ to be fixed to the power case 110′. When the power cord 60 is coupled to the power case 110′, it may contact (or have pressure applied by) one surface of the power cord 60 facing the inner surface of the power cover 130′, maintaining and/or ensuring the coupling of the power cord 60 to the power case 110′.

FIG. 13 is a control block diagram illustrating a refrigerator according to an embodiment of the disclosure.

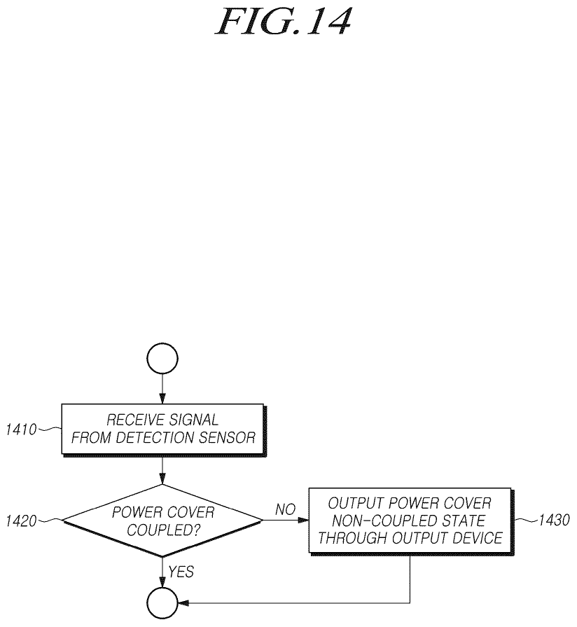

FIG. 14 is a control flowchart illustrating a refrigerator according to an embodiment of the disclosure.

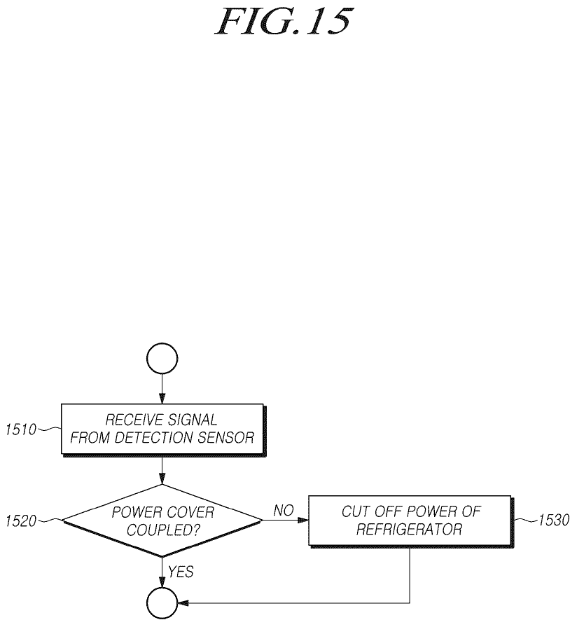

FIG. 15 is a control flowchart illustrating a refrigerator according to an embodiment of the disclosure.

The embodiments of FIGS. 13 to 15 may correspond to the embodiments of FIGS. 1 to 12, and at least some of the embodiments of FIGS. 13 and 15 may be selectively combined with the embodiments of FIGS. 1 to 12.

According to one or more embodiments, the coupling detection sensor 140 of FIG. 13 may be identical in whole or part to the coupling detection sensor 140 of FIGS. 6, 7, 9, and 11.

Referring to FIG. 13, the refrigerator may include a coupling detection sensor 140 for detecting the coupling of the power cover (e.g., the power cover 130 of FIG. 5), a controller 150 for controlling the operation of the refrigerator, and an output device 160 for outputting operation information and/or a state of the refrigerator.

According to an embodiment, the coupling detection sensor 140 may be configured to detect whether the power cover 130 is coupled to the power case (e.g., the power case 110 of FIG. 5). For example, the coupling detection sensor 140 may be implemented as a micro switch, a reed switch, or a hall sensor as described above. The coupling detection sensor 140 may transmit a detection signal (e.g., current) of the power cover 130 to the controller 150.

According to an embodiment, the controller 150 may include a processor 152 configured to control the operation of electrical components disposed inside the refrigerator, such as a cold air supply device, and a memory 154 for storing information (or data) about the operation and/or state of the refrigerator.

According to an embodiment, the controller 150 may be configured to receive a coupling detection signal of the power cover 130 from the coupling detection sensor 140, and determine whether the power cover 130 is completely coupled based on the received signal.

According to an embodiment, the output device 160 may include a notification device 162 that outputs the operation information and/or the state of the refrigerator in the form of a sound, and a display 164 that outputs the operation information and/or the state of the refrigerator in the form of an image. The notification device 162 may include, e.g., a buzzer or a speaker. According to one or more embodiments, the output device 160 can be remote from the refrigerator 1. For example, the output device 160 can be a user device, such as a smartphone, that can wiredly or wirelessly receive electronic communications from the controller 150.

FIG. 14 is a control flowchart for providing a notification through the output device 160 based on a result of determining whether the power cover 130 is coupled based on a signal from the coupling detection sensor 140.

Referring to FIG. 14, in an embodiment, the controller 150 may receive a signal related to whether the power cover 130 is coupled from the coupling detection sensor 140 (Operation 1410). The signal may be, e.g., a current value. In an embodiment, the controller 150 may be configured to determine whether the power cover 130 is coupled to the power case 110 based on a signal (e.g., a signal value) received from the coupling detection sensor 140 (Operation 1420). For example, when a signal (e.g., a current value) received from the coupling detection sensor 140 is smaller than a preset value, the controller 150 may determine that the power cover 130 is not coupled to the power case 110 (“Yes” in Operation 1420). For example, when the signal (e.g., a current value) received from the coupling detection sensor 140 is equal to or larger than the preset value, the controller 150 may determine that the power cover 130 is coupled to the power case 110 (“No” in Operation 1420). When it is determined that the power cover 130 is not coupled to the power case 110 (“No” in 1420), the controller 150 may output information indicating that the power cover 130 is not coupled through the output device 160 (Operation 1430).

FIG. 15 is a control flowchart for cutting off the power of the refrigerator based on a result of determining whether the power cover 130 is coupled based on a signal from the coupling detection sensor 140.

Referring to FIG. 15, in an embodiment, the controller 150 may receive a signal related to whether the power cover 130 is coupled from the coupling detection sensor 140 (Operation 1510). The signal may be, e.g., a current value. In an embodiment, the controller 150 may be configured to determine whether the power cover 130 is coupled to the power case 110 based on a signal received from the coupling detection sensor 140 (Operation 1520). For example, when the signal (e.g., a current value) received from the coupling detection sensor 140 is smaller than a preset value, the controller 150 may determine that the power cover 130 is not coupled to the power case 110 (“No” in Operation 1520). For example, when the signal (e.g., a current value) received from the coupling detection sensor 140 is equal to or larger than the preset value, the controller 150 may determine that the power cover 130 is coupled to the power case 110 (“Yes” in Operation 1520). When it is determined that the power cover 130 is not coupled to the power case 110 (“No” in Operation 1520), the controller 150 may cut off the power supplied to the electrical component disposed in the refrigerator such as the cold air supply device (Operation 1530).

In the disclosure, the structure of the power connector 100 for ensuring or maintaining the complete coupling of the power cord and reduction of fire spread may be applied in substantially the same manner to home appliances requiring power supply as well as the refrigerator. For example, such home appliances may include air conditioners and washers as well as refrigerators.

According to an embodiment, a refrigerator may comprise a main body 10 forming a storage compartment 21, 22, 23 for storing food, a door 31, 32, 33, 34 rotatably connected to the main body 10 to open/close the storage compartment 21, 22, 23, a control box 50 disposed on one surface of the main body 10 to receive an electrical component 53 for receiving power and controlling an operation of the refrigerator, a power connector 100 electrically connected to the electrical component 53, and a power cord 60 couplable to or separable from the power connector 100. The power connector 100 may include a power case 110, a power socket 120 coupled to the power case 110 and coupled with the power cord 60, and a power cover 130 couplable to or separable from one surface 110a of the power case 110 to cover the power socket 120. When coupled with the power case 110, the power cover 130 may cover the power cord 60 coupled to the power connector 100 while contacting one side of the power cord 60.

According to an embodiment, the power cover 130 may be slidably connected to the power case 110 to open/close at least a portion of the one surface 110a of the power case 110. One side of the power cord 60 coupled to the power connector 100 may contact the power cover 130 or be covered from the power cover 130 based on a sliding operation of the power cover 130.

According to an embodiment, the power case 110 may include a socket coupler 111 having one open side for insertion of the power socket 120 and a slide rib 114 extending to surround at least a portion of the socket coupler 111. The slide rib 114 may include a first rib 1141 having a first recess formed in one surface thereof and a second rib 1142 spaced apart from the first rib 1141 and having a second recess formed in one surface opposite to the one surface of the first rib 1141.

According to an embodiment, the power cover 130 may include a side wall 132 protruding from an inner surface 130b and extending along an edge portion of the inner surface 130b. The side wall 132 may include a first side wall 1321 and a second side wall 1322 disposed substantially in parallel to each other, and wherein the first side wall 1321 and the second side wall 1322 include fasteners 1321b, 1322b, respectively, engaged with the first rib 1141 and the second rib 1142 of the slide rib 114.

According to an embodiment, the power cover 130′ may be rotatably coupled to the power case 110′ to cover at least a portion of the one surface 110a of the power case 110. One side of the power cord 60 coupled to the power connector 100 may contact the power cover 130 or be covered from the power cover 130 based on a rotating operation of the power cover 130.

The power cover 130′ may include a pair of fixing protrusions 134 protruding from the inner surface 130b and spaced apart from each other. The power case 110′ may include a fixing hole 116 provided at a position facing the pair of fixing protrusions 134 and where the pair of fixing protrusions 134 are inserted when the power cover 130′ is closed.

According to an embodiment, the power cover 130 may be coupled to the power case 110 by a fastening member including a screw.

According to an embodiment, the power connector 100 may further include a coupling detection sensor 140 spaced apart from the power socket 120, coupled to the power case 110, and configured to detect whether the power cover 130 is coupled.

According to an embodiment, the refrigerator 1 may further comprise an output device 160 configured to output a coupling state of the power cover 130, and a processor 152 configured to control an operation of the output device 160 based on a signal value of the coupling detection sensor 140.

According to an embodiment, the refrigerator 1 may further comprise a processor 152 configured to cut off power of the refrigerator based on a signal value of the coupling detection sensor 140.

According to an embodiment, the coupling detection sensor 140 is selected from a group consisting of a micro switch, a reed switch, and a hall sensor.

According to an embodiment, when the coupling detection sensor 140 is the reed switch or the hall sensor, the power cover 130 may include a magnetic body disposed to face the coupling detection sensor 140 when the power case 110 and the power cover 130 are coupled.

According to an embodiment, the electrical component disposed in the control box 50 may include a circuit board electrically connected to the power connector 100. The power connector 100 may be spaced apart from the circuit board 53.

According to an embodiment, the electrical component disposed in the control box 50 may include a circuit board electrically connected to the power connector 100. The power connector 100 may be disposed on the circuit board 53.

The power case 110 and the power cover 130 may be formed of a flame-retardant material.

According to an embodiment, a home appliance may comprise a main body, a control box 50 disposed on one surface of the main body to receive an electrical component 53 for receiving power and controlling an operation of the home appliance, a power connector 100 disposed in the control box 50 and electrically connected to the electrical component 53, and a power cord 60 couplable to or separable from the power connector 100. The power connector 100 may include a power case 110, a power socket 120 coupled to the power case 110 and coupled with the power cord 60, and a power cover 130 couplable to or separable from one surface 110a of the power case 110 to cover the power socket 120. When coupled with the power case 110, the power cover 130 may cover the power cord 60 coupled to the power connector 100 while contacting one side of the power cord 60.

According to an embodiment, the power cover 130 may be slidably connected to the power case 110 to open or close at least a portion of the one surface 110a of the power case 110. One side of the power cord 60 coupled to the power connector 100 may contact the power cover 130 or be covered from the power cover 130 based on a sliding operation of the power cover 130.

According to an embodiment, the power case 110 may include a socket coupler 111 having one open side for insertion of the power socket 120 and a slide rib 114 extending to surround at least a portion of the socket coupler 111. The slide rib 114 may include a first rib 1141 having a first recess formed in one surface thereof and a second rib 1142 spaced apart from the first rib 1141 and having a second recess formed in one surface opposite to the one surface of the first rib 1141.

According to an embodiment, the power cover 130 may include a side wall 132 protruding from an inner surface 130b and extending along an edge portion of the inner surface 130b. The side wall 132 may include a first side wall 1321 and a second side wall 1322 disposed substantially in parallel to each other, and wherein the first side wall 1321 and the second side wall 1322 include fasteners 1321b, 1322b, respectively, engaged with the first rib 1141 and the second rib 1142 of the slide rib 114.

10 According to an embodiment, the power connector 100 may further include a coupling detection sensor 140 spaced apart from the power socket 120, coupled to the power case 110, and configured to detect whether the power cover 130 is coupled.

What is claimed is:

1. A refrigerator, comprising:
a main body forming a storage compartment for storing food;
a door rotatably connected to the main body to open/close the storage compartment;
a control box disposed on one surface of the main body to receive an electrical component for receiving power and controlling an operation of the refrigerator;
a power connector electrically connected to the electrical component; and
a power cord couplable to or separable from the power connector,
wherein the power connector includes a power case, a power socket coupled to the power case and coupled with the power cord, and a power cover couplable to or separable from one surface of the power case to cover the power socket, and
wherein when coupled with the power case, the power cover covers the power cord coupled to the power connector while contacting one side of the power cord.

2. The refrigerator of claim 1, wherein the power cover is slidably connected to the power case to open or close at least a portion of the one surface of the power case, and
wherein one side of the power cord coupled to the power connector contacts the power cover or is covered from the power cover based on a sliding operation of the power cover.

3. The refrigerator of claim 2, wherein the power case includes a socket coupler having one open side for insertion of the power socket and a slide rib extending to surround at least a portion of the socket coupler, and
wherein the slide rib includes a first rib having a first recess formed in one surface thereof and a second rib spaced apart from the first rib and having a second recess formed in one surface opposite to the one surface of the first rib.

4. The refrigerator of claim 3, wherein the power cover includes a side wall protruding from an inner surface and extending along an edge portion of the inner surface,
wherein the side wall includes a first side wall and a second side wall disposed substantially in parallel to each other, and
wherein the first side wall and the second side wall include fasteners, respectively, engaged with the first rib and the second rib of the slide rib.

5. The refrigerator of claim 1, wherein the power cover is rotatably coupled to the power case to cover at least a portion of the one surface of the power case, and
wherein one side of the power cord coupled to the power connector contacts the power cover or is covered from the power cover based on a rotating operation of the power cover.

6. The refrigerator of claim 5, wherein the power cover includes a pair of fixing protrusions protruding from an inner surface and spaced apart from each other, and
wherein the power case includes a fixing hole provided at a position facing the pair of fixing protrusions and wherein the pair of fixing protrusions are inserted when the power cover is closed.

7. The refrigerator of claim 1, wherein the power cover is coupled to the power case by a fastening member including a screw.

8. The refrigerator of claim 1, wherein the power connector further includes a coupling detection sensor spaced apart from the power socket, coupled to the power case, and configured to detect whether the power cover is coupled.

9. The refrigerator of claim 8, further comprising:
an output device configured to output a coupling state of the power cover; and
a processor configured to control an operation of the output device based on a signal value of the coupling detection sensor.

10. The refrigerator of claim 8, further comprising a processor configured to cut off the power of the refrigerator based on a signal value of the coupling detection sensor.

11. The refrigerator of claim 8, wherein the coupling detection sensor is selected from a group consisting of a micro switch, a reed switch, and a hall sensor.

12. The refrigerator of claim 11, wherein when the coupling detection sensor is the reed switch or the hall sensor, the power cover includes a magnetic body disposed to face the coupling detection sensor when the power case and the power cover are coupled.

13. The refrigerator of claim 1, wherein the electrical component disposed in the control box includes a circuit board electrically connected to the power connector, and
wherein the power connector is spaced apart from the circuit board.

14. The refrigerator of claim 1, wherein the electrical component disposed in the control box includes a circuit board electrically connected to the power connector, and
wherein the power connector is disposed on the circuit board.

15. The refrigerator of claim 1, wherein the power case and the power cover are formed of a flame-retardant material.

16. A home appliance, comprising:
a main body;
a control box disposed on one surface of the main body to receive an electrical component for receiving power and controlling an operation of the home appliance;
a power connector disposed in the control box and electrically connected to the electrical component; and
a power cord couplable to or separable from the power connector,
wherein the power connector includes a power case, a power socket coupled to the power case and coupled with the power cord, and a power cover couplable to or separable from one surface of the power case to cover the power socket, and
wherein when coupled with the power case, the power cover covers the power cord coupled to the power connector while contacting one side of the power cord.

17. The home appliance of claim 16, wherein the power cover is slidably connected to the power case to open or close at least a portion of the one surface of the power case, and
wherein one side of the power cord coupled to the power connector contacts the power cover or is covered from the power cover based on a sliding operation of the power cover.

18. The home appliance of claim 17, wherein the power case includes a socket coupler having one open side for insertion of the power socket and a slide rib extending to surround at least a portion of the socket coupler, and
wherein the slide rib includes a first rib having a first recess formed in one surface thereof and a second rib spaced apart from the first rib and having a second recess formed in one surface opposite to the one surface of the first rib.

19. The home appliance of claim 18, wherein the power cover includes a side wall protruding from an inner surface and extending along an edge portion of the inner surface,
wherein the side wall includes a first side wall and a second side wall disposed in parallel to each other, and
wherein the first side wall and the second side wall include fasteners, respectively, engaged with the first rib and the second rib of the slide rib.

20. The home appliance of claim 16, wherein the power connector further includes a coupling detection sensor spaced apart from the power socket, coupled to the power case, and configured to detect whether the power cover is coupled.
